(19) United States
(12) Patent Application Publication
(10) Pub. No.: US 2003/0165599 A1
(43) Pub. Date: Sep. 4, 2003

(54) Container for preparation of chicken wings

(75) Inventors: James J. Griffin, Syracuse, NY (US); Robert W. Coffey JR., Hastings, NY (US)

Correspondence Address: Bernhard P. Molldrem, Jr., 333 East Onondaga Street, Syracuse, NY, 13202, US

(73) Assignee: R.J. Product Solutions, Inc.

(21) Appl. No.: 10/318,758

(22) Filed: Dec. 16, 2002

Related U.S. Application Data
(60) Provisional application No. 60/361,215, filed on Mar. 1, 2002.

(51) Int. Cl. A23B 4/00

(52) U.S. Cl. 426/302

(57) ABSTRACT

Color-coded bowls for use in applying a sauce to chicken wings or to another food product have reservoir feet that contain the sauce and permit excess sauce to drain from the wings. A matching cover or lid has top structure that mates with the reservoir feet to permit a number of these bowls and lids to be stacked. The bowls and lids may have flat annular horizontal flanges. The reservoir feet may be concentric annular channel members.

### BACKGROUND OF THE INVENTION

This invention relates to containers for use in preparation of food products, and is more particularly directed to a covered bowl that is used in applying a sauce to a food product prior to the serving of the product to a customer.

The invention is also concerned with a process of preparing fried chicken wings or a similar food product, in which the wings are cooked, e.g., deep fried, and then are placed into a container containing a sauce or similar coating, are coated with the sauce, and then are served to the customer. There are other hot and cold food products (e.g., fried pasta) that may be coated or sauced in the vessels or containers used in this process.

Fried chicken wings have become a popular restaurant item, and are frequently served as either an appetizer, a main course, or an hors-d'oeuvre. The chicken wing parts are deep-fried in a frier or fry cooker, and then are covered with a sauce and served to the customers or guests. The sauce that is used is an important taste feature, and generally there are a variety of sauces available so that the wings can be prepared to the customers' particular taste. For example, chicken wings can be prepared with either a “hot” (spicy), “medium” or “mild” sauce, or with a flavored sauce, such as garlic. In any event, because of the importance of the sauce to the overall presentation and flavor of the wings, the food preparation staff has to be careful to use only the sauce that corresponds to the customer's order.

At the present time, there are no suitable vessels or containers provided for coating fried chicken wings, or for coating other food products, with sauce. The current mode is to use an available general purpose container, e.g., a mayonnaise jar, for saucing the fried wings. That is, the cook staff will fry and drain an order of wings, and then pour the wings from the fry basket into the general purpose container. The cook then pours an ample amount of the desired type of sauce on the wings, and covers the container and shakes it to coat the wings. Because of the shape of the container, the wings typically are swimming in a residue of the sauce. This makes it impossible to control the amount of sauce applied, and there is not a consistent application of sauce for each order.

Because some sauce remains in the base of the container, and because there are several identical containers used for hot, mild, and medium sauce, it is quite common for the cookstaff to mistakenly use the wrong container, resulting in the customer's order being too hot or too mild. Typically, the various jars or vessels are labeled with tape as for hot, mild, medium, etc., but after several orders of fried wings have been prepared, the labels can come off the vessel, making it quite confusing for the kitchen staff as to which vessel is for which sauce. This can result in mixing hot and mild sauce, for example, on a given customer order.

### OBJECTS AND SUMMARY OF THE INVENTION

Accordingly, it is an object of this invention to provide a simple and straightforward container or vessel for the more effective preparation of chicken wings or similar finger food which is coated with a sauce or other edible coating prior to being served to the customer.

It is another object to provide a container or vessel with a sauce reservoir feature that allows several orders of wings to be made without having to refill with sauce for each order, and which allows excess sauce to drain from the wings to permit consistent application of sauce for each order of fried wings.

It is a still further object to provide color-coded containers to eliminate confusion of the different types of sauces, so that the customers receive their orders of wings with the sauce that they desired.

It is another object for the shape of the vessel and lid to assist in tumbling of the wings as they are shaken so that the wings are uniformly coated.

It is yet another object for the vessel and lid to have features that permit them to be stacked one on top of the next.

In accordance with an aspect of the present invention, a food preparation vessel serves for preparation of a coated food product in which a sauce or similar liquid edible coating is applied onto a finger-held food product just before the product is served to a customer. The vessel has a concave bowl member with a curved (e.g., generally spheric) side wall, a bottom, and an upper rim. The bottom has a plurality of reservoir feet, which appear on the interior of the bowl as grooves of an appropriate size to contain a quantity of sauce or other liquid edible coating. In a suitable embodiment, these grooves can have a width dimension about ½ inch, so that they are narrow enough to prevent said food product from falling into the grooves. This allows the chicken wings or other food product to sit atop the reservoir feet and drain. The cover or lid has a domed (e.g., spheric) central portion and a rim disposed at a periphery of the domed central portion. This rim mates against the rim of the bowl member so that the sauce and wings are contained in the bowl during shaking. Also, the two rims together serve as a handle so that the cook staff can easily grip the vessel for shaking it.

The reservoir feet in the bowl can take the form of a plurality of concentric rings on bottom, such that at least one complementary annular groove is defined on an exterior of the bottom between two of the rings. The lid has an annular ridge formed on the domed central portion thereof, and this annular ridge is adapted to seat into the above-mentioned complementary annular groove. This construction permits a number of similar vessels to be stacked one on top of the other, so that the various wing bowls (for the various types or strengths of sauce) can be kept in an orderly fashion in the kitchen work space.

Both the concave bowl member and the domed lid can favorably be molded of a plastic resin suitable for food handling. Preferably distinctive, FDA-approved dyes or colorants are included in the plastic material, so that the color of the vessel is coded to correspond to the type of sauce contained in it.

In a preferred embodiment, the rim of the bowl member has a flat horizontal annular flange and there is an annular step joining the curved side wall and the flat, horizontal flange. In this embodiment, the rim on the lid also has a flat horizontal annular flange, and an annular step that joins the flange and the domed central portion. With this construction, when the lid is placed upon the bowl member, the annular step of the lid mates against the annular step of the bowl member.

In another of many possible embodiments, the reservoir feet can extend radially on the bottom of said bowl member, and these appear as radial ridges on the exterior of the bottom. In that embodiment, the lid can have corresponding radial grooves that mate with the radial ridges on the bottom of the bowl, so these may also be stacked.

The rounded shape of the bowl and lid, and the presence of the reservoir feet, i.e., interior grooves, facilitate in the rolling or tumbling of the chicken wings during shaking, so that the coating of sauce is more uniform.

In the method of preparation of this invention, the cook staff prepares and fries the chicken wings in a fry cooker, and when the wings have been sufficiently cooked, the cook staff removes the wings from the cooker for application of sauce to the fried wings. The wings can then be served, with their coating of the desired sauce, to the customer. Here, the step of coating or saucing involves pouring or otherwise moving the fried wings from the fry basket into the saucing vessel, and the vessel comprises a concave bowl member having a curved side wall, a bottom, and an upper rim, and a corresponding lid or cover. The bottom of the bowl member has a plurality of reservoir feet that appear as grooves of a sufficient size to contain a quantity of sauce. The grooves have a width dimension (e.g., ½ inch) that is narrow enough to prevent the food product from falling into the grooves. Then the lid is positioned on bowl member. The lid, as discussed above, has a domed central portion and a rim disposed at a periphery of the domed central portion, so that the rim mates against the rim of the bowl member. The cook then shakes the bowl with the lid on, and coats the fried wings in said sauce. The lid is removed, and the coated wings can be scooped or poured from bowl member onto a serving dish so the sauced wings may be served to the customer.

Preferably, there are three or more sets of bowl members and corresponding lids, and these sets are color coded to correspond to type of sauce contained therein, e.g., red for “hot” or spicy, blue for “mild”, green for “garlic”, etc. The bowls and lids are constructed with means to mate with grooves of the bottom of the bowl members, and the three or more sets of color-coded bowl members and lids are interlocked into a stack.

With this system, the appropriate amount of sauce is consistently applied to each order of wings, and the chance of mistakenly applying the wrong type of sauce, or of inadvertently using the wrong container for a type of sauce, is minimized.

The above and many other objects, features, and advantages of this invention will become apparent to persons skilled in the art from the ensuing description of a preferred embodiment, which is to be read in conjunction with the accompanying Drawing.

### BRIEF DESCRIPTION OF THE DRAWING

FIG. 1 is a perspective view of the wing saucing vessel of one embodiment of this invention.

FIG. 2 is a top plan view of the bowl portion of this embodiment.

FIG. 3 is a cross-sectional view of the bowl and lid of this embodiment.

FIG. 4 is a side elevation of three sets of bowls and lids of this embodiment stacked atop one another.

FIG. 5 is a top plan view of a second embodiment.

FIG. 6 is a side elevation of the second embodiment.

### DETAILED DESCRIPTION OF THE PREFERRED EMBODIMENT

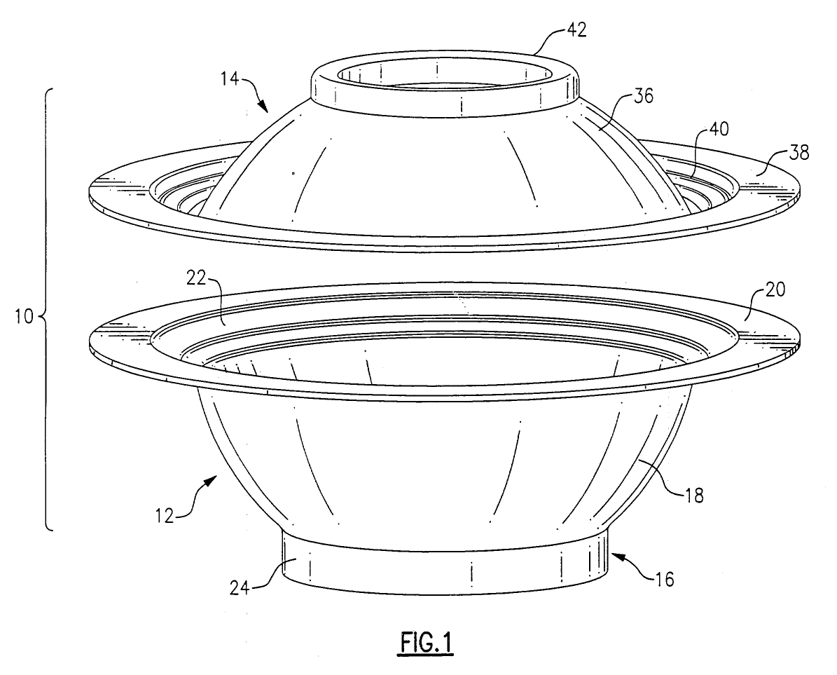

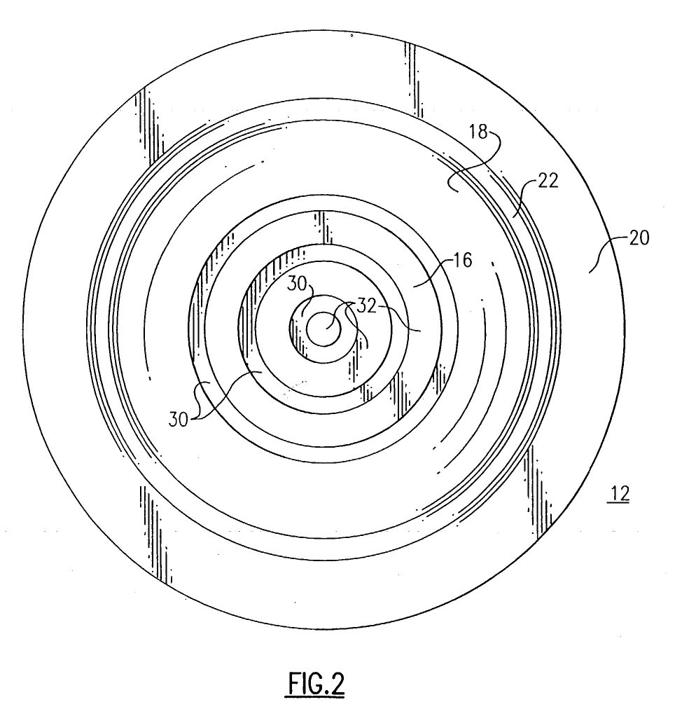

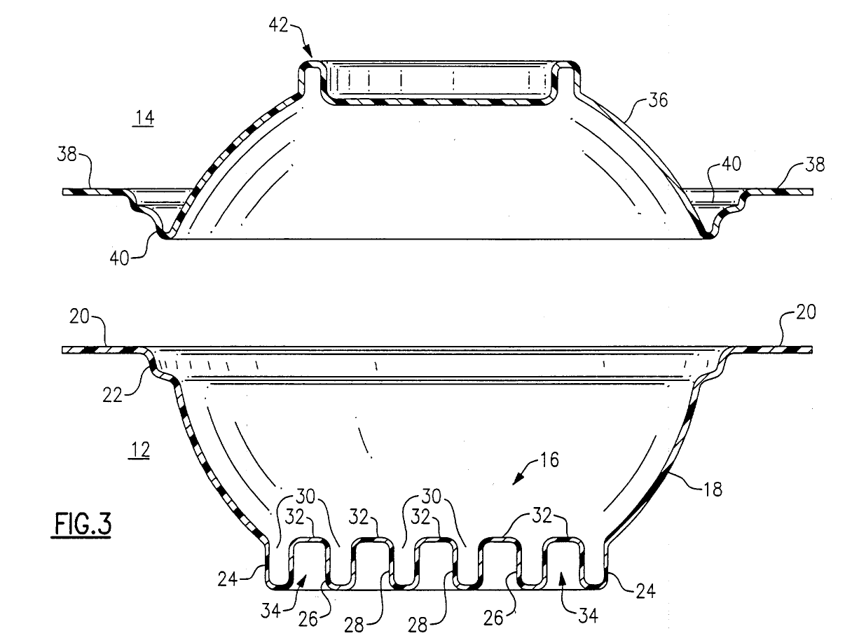

With reference to the Drawing, and initially to FIGS. 1, 2, and 3, a wing bowl vessel 10 for coating fried food items with sauce has a lower bowl member 12 and a lid or cover 14.

In this embodiment, the bowl member 12 has a base or bottom 16 and a round, i.e., spheric side wall 18 (this side wall could be oblong or oval in some embodiments). There is a flat annular rim 20, that is, a horizontal flange, extending out from the top of the side wall 18, with an annular step 22 between the top of the side wall 18 the inside of the annular rim 20.

At the base or bottom 14 are a number of hollow reservoir feet, here in the form of concentric annular channels 24, 26, and 28. On the inside of the bowl member, these channels appear as concentric grooves 30 with lands 32 appearing between them. Here, the grooves 30 are continuous, i.e., without end walls, which facilitates rinsing and cleaning. The reservoir feet or channels 24, 26, 28 can have a width of ½ inch and a depth of about one inch. The edges of the grooves are radiused so that the grooves are easier to rinse out. With these dimensions, any fried chicken wings would rest on the lands 32 and not fall into the grooves 30, so that excess sauce would be permitted to drain off the wings. On the other hand, the grooves 30 are of sufficient volume to contain approximately enough sauce for three servings of wings, so that sauce does not have to be added for each use.

At the underside of the bottom 16 of the bowl member, an annular channel 34 is defined between the outermost and the next of the annular reservoir channels 24 and 26.

The lid or cover 14 of this embodiment has a domed central portion 36, i.e. of a generally spherical shape, with a flat annular horizontal rim 38 disposed about its periphery. There is an annular step 40 joining the lower edge of the domed central portion 36 to the rim 38, with the rim 38 positioned above the lower edge of the central portion 36. The rims 20 and 38 and the annular steps 22 and 40 are dimensioned respectively to seat against one another. The cook can grip the bowl member 12 and lid 14 with his or her hands on the adjacent rims 20 and 38 for holding the wing bowl vessel 10 and for shaking it to coat the wings with sauce.

An annular ridge 42 is formed on the top of the domed portion 36 of the lid, and this ridge 32 is dimensioned to fit into the space 34. This feature permits a number of similar sets of bowl members and lids, i.e., a number of wing bowl vessels 10, to be stacked one on top of the next.

Preferably, the bowl member 12 and lid 14 are molded of a tough, food-grade plastic resin, e.g., by injection molding. A suitable FDA-approved dye or colorant can be added into the plastic resin before molding. Different colors are available so that the bowls and lids can be color coded, for example, for each type or strength of sauce.

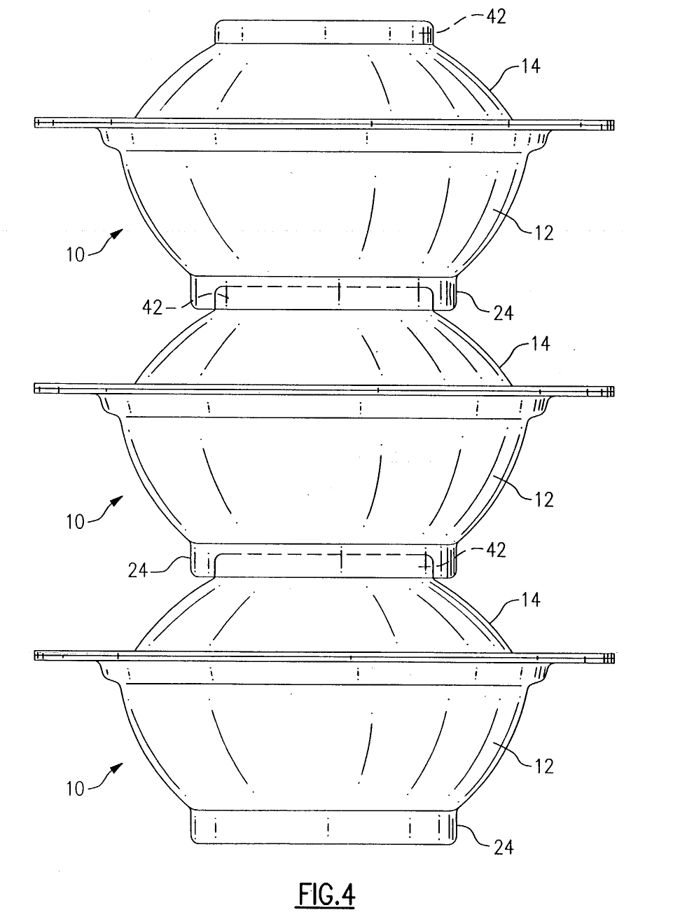

As mentioned above, the wing bowl vessels 10 can be stacked one atop another, and FIG. 4 illustrates a group of three of these with the ridge 42 of each lid 14 fitting into the channel 34 that is inside the outermost annular reservoir foot 24 of the bowl member 12 just above it. The foot 24 of the lowest bowl member sits on the work surface. This stacking feature permits a number of these wing bowl vessels to be consolidated onto a small footprint on the kitchen work surface, with the capability of selecting easily among a number of different strengths or styles of sauce. As also discussed, the three wing bowl vessels or sets 10 can be of contrasting colors, to correspond, e.g., to “hot”, “mild”, and “medium” respectively. With the color coding, the kitchen staff is much less likely to mistakenly apply the wrong sauce to a customer's order for wings.

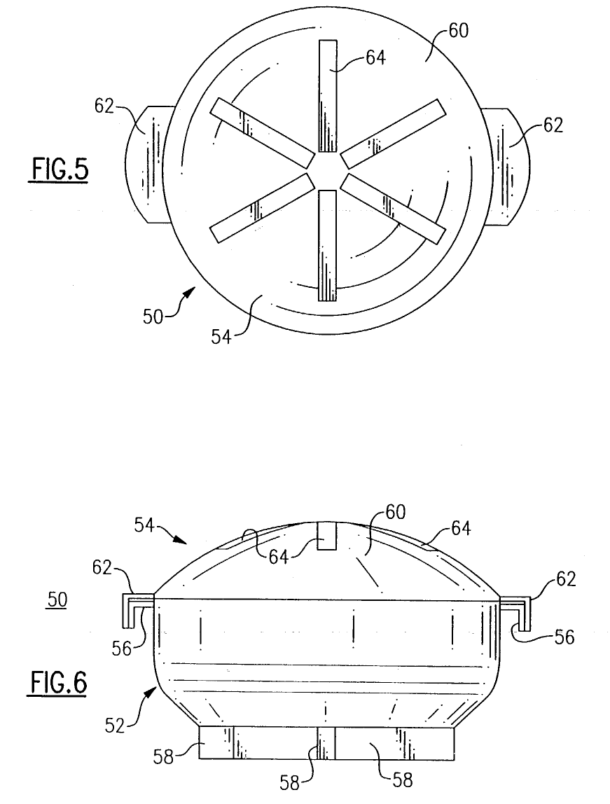

FIGS. 5 and 6 illustrate a second of many possible embodiments. In this case, the vessel is a two-part set 50 consisting of a bowl member 52 and a lid or cover 54. The bowl member 52

In addition to the application for chicken wings, the bowl and lid combination can be used for applying sauces of various types on a wide variety of food products, including main courses, appetizers, and desserts, which can be hot, room temperature, or frozen foods such as ice cream.

While the invention has been described in detail with respect to specific preferred embodiments, it should be recognized that there are many alternative embodiments that would become apparent to persons of skill in the art. Many modifications and variations are possible which would not depart from the scope and spirit of this invention, as defined in the appended claims.

I claim:

1. A food preparation vessel for preparation of a coated food product in which a sauce or similar liquid edible coating is applied onto a finger-held food product just before the product is served to a customer, comprising a concave bowl member having a curved side wall, a bottom, and an upper rim, said bottom having a plurality of grooves therein of a sufficient size to contain a quantity of said liquid edible coating and said grooves having a width dimension that is sufficiently narrow to prevent said food product from falling into the grooves; and a lid having a domed central portion and a rim disposed at a periphery of said domed central portion and adapted to mate against the rim of the bowl member.

2. Food preparation vessel according to claim 1 wherein said grooves comprise a plurality of concentric grooves on said bottom, such that at least one complementary annular groove is defined between two of said grooves on an exterior of said bottom.

3. Food preparation vessel according to claim 2 wherein said lid has an annular ridge formed on the domed central portion thereof, and said annular ridge is adapted to seat on said complementary annular groove.

4. Food preparation vessel according to claim 1 wherein said concave bowl member and said lid are molded of a plastic resin suitable for food handling, and which contains a colorant chosen such that the color of the vessel is coded for the type of sauce contained therein.

5. Food preparation vessel according to claim 1 wherein the rim of said bowl member has a flat horizontal annular flange and an annular step joining the curved side wall and said flange.

6. Food preparation vessel according to claim 5 wherein said rim of said lid has a flat horizontal annular flange, and an annular step joining said flange and said domed central portion such that when the lid is placed upon said bowl member, the annular step of said lid mates against the annular step of said bowl member.

7. Food preparation vessel according to claim 1 wherein said grooves extend radially on the bottom of said bowl member, and which appear as radial ridges on an exterior of said bottom, and wherein said lid has corresponding radial grooves that mate with said radial ridges.

8. A method of preparing fried chicken wings for consumption by a customer, comprising the steps of preparing and frying the wings in a fry cooker; removing the wings from the cooker; coating the fried wings in sauce; and serving the coated wings to the customer; wherein said step of coating includes placing the wings in a vessel that comprises a concave bowl member having a curved side wall, a bottom, and an upper rim, said bottom having a plurality of grooves therein of a sufficient size to contain a quantity of said sauce and said grooves having a width dimension that is sufficiently narrow to prevent said food product from falling into the grooves; placing on said bowl member a lid that has a domed central portion and a rim disposed at a periphery of said domed central portion and adapted to mate against the rim of the bowl member; shaking the bowl with the lid thereon to coat said fried wings in said sauce; removing said lid; and removing the coated wings from said bowl member so they may be served to the customer.

9. The method of claim 8 wherein there are three or more sets of bowl members and corresponding lid; and said sets are of different respective colors, coded to correspond to type of sauce contained therein, so that the bowl and lid set for the customer's choice of sauce may be selected by the corresponding color.

10. The method of claim 9 wherein said lids are constructed with means to mate with the grooves of the bottom of the bowl members, and said three or more sets of color-coded bowl members and lids are interlocked into a stack.
